(19) United States
(12) Patent Application Publication
(10) Pub. No.: US 2026/0259518 A1
(43) Pub. Date: Sep. 3, 2026

(54) SCANNING OPTICAL DEVICE AND IMAGE FORMING APPARATUS

(71) Applicant: CANON KABUSHIKI KAISHA, Tokyo (JP)

(72) Inventor: JUN NAGATOSHI, Tokyo (JP)

(21) Appl. No.: 19/554,192

(22) Filed: Mar. 2, 2026

(30) Foreign Application Priority Data
Mar. 3, 2025 (JP) 2025-032908
Dec. 22, 2025 (JP) 2025-272208

(51) Int. Cl. G03G 15/04; B41J 2/44; B41J 2/47; G03G 15/00; G03G 15/041; G03G 21/16; G02B 26/12

(52) U.S. Cl. CPC G03G 15/04036; B41J 2/44; B41J 2/471; G03G 15/0415; G03G 15/6552; G03G 21/1647; G02B 26/124

(57) ABSTRACT

A scanning optical device includes a first lens through which a light beam is transmitted, a deflector including a polygon mirror, a second lens through which the light beam scanned by the deflector is transmitted and a mirror for reflecting the deflected light beam. A casing holds the first and second lenses, light deflector and mirror, and includes an opening through which the deflector, second lens and mirror are mounted on the casing. A lid covers a part of the opening. As viewed in a rotational axis direction of the polygon mirror from a side of the lid, the lid does not cover the mirror but covers the first lens and polygon mirror. In a state in which the part of the opening is covered by the lid, the first lens and polygon mirror are in a space formed and obstructed by the lid, casing and second lens.

### BACKGROUND

### Field of the Technology

The present invention relates to a scanning optical device equipped to an image forming apparatus such as a laser beam printer and a digital copy machine, which forms a toner image on a sheet by using an electrophotographic recording process, and to the image forming apparatus on which the scanning optical device is equipped.

### Description of the Related Art

In a scanning optical device used for an image forming apparatus of an electrophotographic recording type, a light deflector, a scanning lens, and a reflecting mirror are accommodated in a casing. In a scanning optical device described in Japanese Patent Application Laid-Open No. H10-119356, of openings of a casing of the scanning optical device, approximately all openings other than an opening, from which a light beam is emitted, are covered by a lid. As for a scanning optical device described in Japanese Patent Application Laid-Open No. H07-129060, by providing a reflecting mirror outside a casing, the scanning optical device is downsized.

However, in the configuration in which approximately all openings of the casing other than the laser emitting opening are covered by the lid, a size of the lid is increased. In addition, in the configuration in which the reflecting mirror is provided outside the casing, errors in a position and a posture of the reflecting mirror become larger than errors in positions and postures of other optical elements fixed to the casing. As a result, accuracy of irradiating position of the light beam deteriorates.

### SUMMARY

The present disclosure is conceived under a background as described above, and an object of the present disclosure is, while ensuring accuracy of irradiating position of a light beam, to provide a scanning optical device which realizes downsizing and cost reduction thereof.

According to an aspect of the present invention, the followings are provided:

A scanning optical device for scanning a scanned member with a light beam depending on image information; the scanning optical device comprising: a first lens through which the light beam emitted from a light source is transmitted; a light deflector including a rotatable polygon mirror for deflecting and scanning the light beam transmitted from the first lens; a second lens through which the light beam deflected and scanned by the light deflector is transmitted; a mirror configured to reflect the light beam transmitted from the second lens and to guide to the scanned member; a casing configured to hold the first lens, the light deflector, the second lens and the mirror, the casing including an edge portion for forming an opening through which the first lens, the light deflector, the second lens and the mirror are mounted on the casing; and a lid configured to cover a part of the opening, wherein a direction from a first seat surface, of the casing, which holds the light deflector and toward the light deflector and perpendicular to the first seat surface, and a direction from a second seat surface, of the casing, which holds the second lens and is parallel to the first seat surface toward the second lens held by the second seat surface and perpendicular to the second seat surface are the same direction, wherein as the scanning optical device is viewed in a rotational axis direction of the rotatable polygon mirror from a side of the lid, the lid does not cover the mirror but covers the first lens and the rotatable polygon mirror, and wherein in a state in which the part of the opening is covered by the lid, the first lens and the rotatable polygon mirror are in a space formed and obstructed by the lid, the casing and the second lens held by the second seat surface.

A scanning optical device for scanning a scanned member with a light beam depending on image information; the scanning optical device comprising: a first lens through which the light beam emitted from a light source is transmitted; a light deflector including a rotatable polygon mirror for deflecting and scanning the light beam transmitted from the first lens; a second lens through which the light beam deflected and scanned by the light deflector is transmitted; a mirror configured to reflect the light beam transmitted from the second lens and to guide to the scanned member; a casing configured to hold the first lens, the light deflector, the second lens and the mirror, the casing including an edge portion for forming an opening through which the first lens, the light deflector, the second lens and the mirror are mounted on the casing; a first spring configured to urge one end of the mirror to the casing with respect to a longitudinal direction of the mirror and a second spring configured to urge the other end of the mirror to the casing; a first lid configured to cover a part of the opening; and a second lid configured to cover the mirror, the first spring and the second spring, wherein a direction from a first seat surface, of the casing, which holds the light deflector and toward the light deflector and perpendicular to the first seat surface, and a direction from a second seat surface, of the casing, which holds the second lens and is parallel to the first seat surface toward the second lens held by the second seat surface and perpendicular to the second seat surface are the same direction, wherein as the scanning optical device is viewed in a rotational axis direction of the rotatable polygon mirror from a side of the first lid, the first lid does not cover the mirror and covers the first lens and the rotatable polygon mirror, and wherein in a state in which the part of the opening is covered by the first lid, the first lens and the rotatable polygon mirror are in a space formed and obstructed by the first lid, the casing and the second lens held by the second seat surface.

A scanning optical device for scanning a scanned member with a light beam depending on image information; the scanning optical device comprising: a first lens through which the light beam emitted from a light source is transmitted; a light deflector including a rotatable polygon mirror for deflecting and scanning the light beam transmitted from the first lens; a second lens through which the light beam deflected and scanned by the light deflector is transmitted; a mirror configured to reflect the light beam transmitted from the second lens and to guide to the scanned member; a casing configured to hold the first lens, the light deflector, the second lens and the mirror, the casing including an edge portion for forming an opening through which the first lens, the light deflector, the second lens and the mirror are mounted on the casing; a first spring configured to urge one end of the mirror to the casing with respect to a longitudinal direction of the mirror and a second spring configured to urge another end of the mirror to the casing; and a lid configured to cover a part of the opening, wherein a direction from a first seat surface, of the casing, which holds the light deflector and toward the light deflector and perpendicular to the first seat surface, and a direction from a second seat surface, of the casing, which holds the second lens and is parallel to the first seat surface toward the second lens held by the second seat surface and perpendicular to the second seat surface are the same direction, wherein the light beam reflected by the mirror is emitted from an emitting opening provided on the casing to an outside of the scanning optical device, wherein as the scanning optical device is viewed in a rotational axis direction of the rotatable polygon mirror from a side of the lid, the lid covers the first lens and the rotatable polygon mirror, and further covers at least the first spring and the second spring, of the mirror, the first spring and the second spring, wherein the lid is provided with an opening or a cutout portion through which an inside of the casing is exposed on a downstream side of the second lens in an optical axis direction of the light beam passing through the second lens and an advancing direction of the light beam passing through the second lens, and wherein in a state in which a part of the opening of the casing is covered by the lid, the first lens and the rotatable polygon mirror are in a space formed and obstructed by the lid, the casing and the second lens held by the second seat surface.

Further features of the present invention will become apparent from the following description of exemplary embodiments with reference to the attached drawings. The following description of embodiments is described by way of example.

### BRIEF DESCRIPTION OF THE DRAWINGS

FIG. 1 is a cross-sectional view illustrating image forming apparatuses in Embodiments 1 through 4.

FIG. 2 is a perspective view illustrating an internal configuration of a scanning optical device in the Embodiments 1 through 4.

FIG. 3 is a perspective view illustrating a state in which a lid in the Embodiment 1 is being assembled to an optical box.

FIG. 4 is a perspective view illustrating the scanning optical device to which the lid in the Embodiment 1 is assembled.

FIG. 5, part (a) and part (b), includes cross-sectional views of the scanning optical device in the Embodiment 1.

FIG. 6 is a cross-sectional view illustrating a positional relationship between the scanning optical device and a discharge tray in the Embodiment 1.

FIG. 7 is a perspective view illustrating a scanning optical device in the Embodiment 2.

FIG. 8 is a perspective view illustrating a state in which a lid in the Embodiment 3 is being assembled to an optical box.

FIG. 9 is a perspective view of the scanning optical device in the Embodiment 3 as viewed from an emitting opening side.

FIG. 10 is a perspective view illustrating a Modified Example of the scanning optical device in the Embodiment 3.

FIG. 11 is a perspective view illustrating a scanning optical device in the Embodiment 4.

FIG. 12 is a perspective view of a Modified Example of the scanning optical device in the Embodiment 1.

FIG. 13, part (a) and part (b), includes cross-sectional views of the Modified Example of the scanning optical device in the Embodiment 1.

FIG. 14, part (a) and part (b), includes cross-sectional views of the modified example of the scanning optical device in the Embodiment 1.

FIG. 15 is a view describing the lid for the scanning optical device in the Embodiment 1.

### DESCRIPTION OF THE EMBODIMENTS

### Embodiment 1

A scanning optical device in an Embodiment 1 of the present invention and an image forming apparatus provided with the scanning optical device will be described. Incidentally, in the following description, first, the image forming apparatus provided with the scanning optical device in the Embodiment 1 will be described by way of example, next, the scanning optical device will be described in detail, and finally, a positional relationship between the scanning optical device and a discharge tray will be described. In the following description and each drawing, a vertical direction when the image forming apparatus is installed on a horizontal plane is defined as a Z direction. A direction crossing the Z direction and being a direction of a rotational axis of a photosensitive member is defined as a Y direction. A direction crossing both the Z direction and the Y direction is defined as an X direction.

### Image forming apparatus

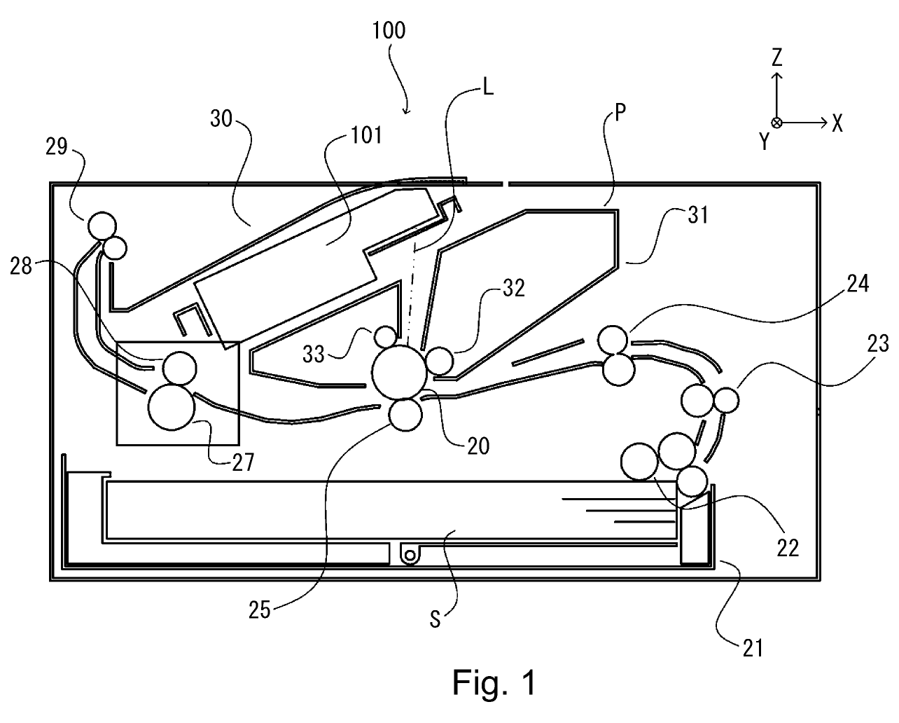

FIG. 1 is a cross-sectional view of an overall configuration of the image forming apparatus in the Embodiment 1. In an image forming apparatus 100, a scanning optical device 101, a photosensitive drum 20, a developing roller 32, a fixing film 28, a pressing roller 27, a sheet feeding tray 21, a sheet feeding roller 22, etc. are provided. A sheet S stacked and accommodated in the sheet feeding tray 21 is fed by the sheet feeding roller 22 rotating in a counterclockwise direction in FIG. 1, and by a conveyance roller pair 23 and 24, the sheet S is sent to a nip portion between the photosensitive drum 20 and a transfer roller 25 (hereinafter, referred to as a transfer nip portion).

The photosensitive drum 20 as a scanned member is rotating in a clockwise direction in FIG. 1. On an outer peripheral surface of the photosensitive drum 20, electrostatic latent images are sequentially formed by a light beam L irradiated from the scanning optical device 101, and subsequently, the electrostatic latent image is developed by toner carried on the developing roller 32, and a toner image is formed. The toner image formed on the photosensitive drum 20 is transferred onto the sheet S, which is sent to the transfer nip portion between the photosensitive drum 20 and the transfer roller 25.

Furthermore, the sheet S to which the toner image has been transferred is sent to a nip portion between the fixing film 28 and the pressing roller 27 (hereinafter, referred to as a fixing nip portion), and is heated and pressed so that an unfixed toner image is fixed to the sheet S here. The sheet S to which the toner image has been fixed is discharged, by a discharging roller pair 29, onto a discharge tray 30. Incidentally, the discharge tray 30 is an example of a tray on which a recording material, to which the toner image has been fixed, are stacked. And the photosensitive drum 20 in the Embodiment 1 is provided so as to be mountable and dismountable with respect to the image forming apparatus 100 as a process cartridge P, in which a charging roller 33, a developing device 31, etc. as process means acting on the photosensitive drum 20 are integrated. The developing roller 32 is an example of a developing portion which develops the electrostatic latent image with the toner and forms the toner image. The transfer roller 25 is an example of a transfer portion for transferring the toner image to the recording material. The fixing film 28 is an example of a fixing portion which fixes the toner image transferred by the transfer portion.

### Scanning optical device

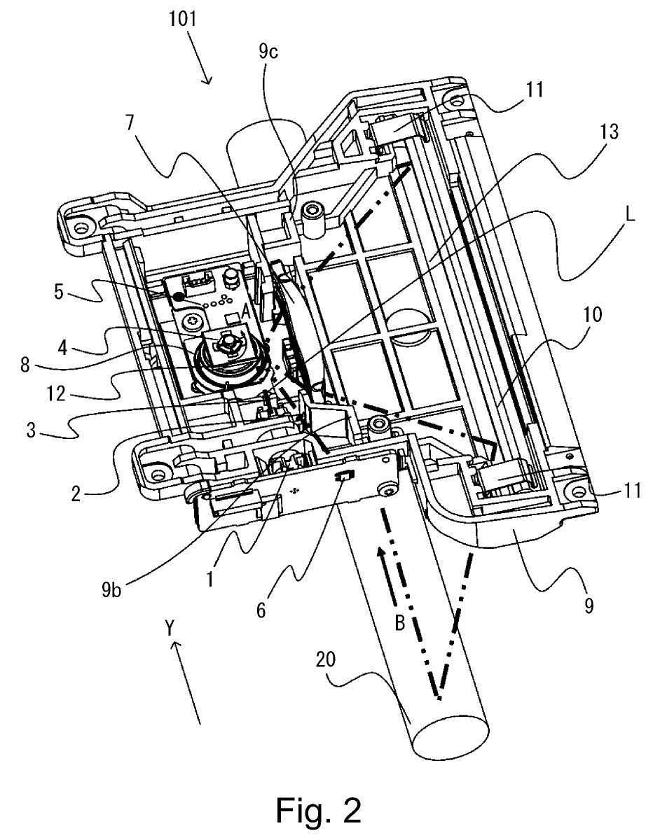

FIG. 2 is a perspective view illustrating an internal configuration of the scanning optical device 101 in the Embodiment 1. The scanning optical device 101 forms the electrostatic latent image on the surface of the photosensitive drum 20 as an image bearing member by using a laser beam. The scanning optical device 101 includes a semiconductor laser unit 1 as a light source which emits a light beam L, and an anamorphic collimator lens 2 in which a collimator lens and a cylindrical lens are integrally formed. The anamorphic collimator lens 2 is an example of a first lens through which the light beam emitted from the light source is transmitted.

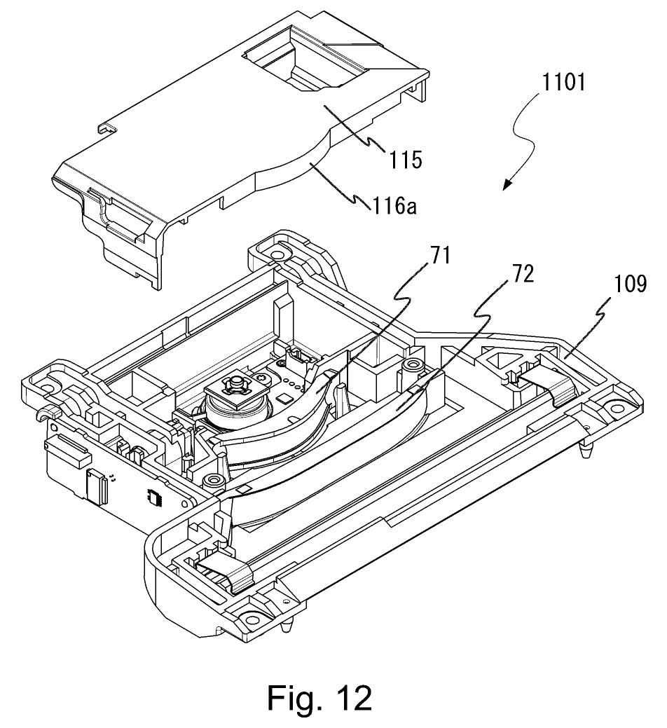

In addition, the scanning optical device 101 includes a main scanning aperture 3 constituted by a groove, a rotatable polygon mirror 4, a motor 8, a beam detector 6 (hereinafter, referred to as a BD 6), a scanning lens 7, a reflecting mirror 10, an optical box 9, a pressing spring 11, and an emitting opening 13. A light deflector 5 includes the rotatable polygon mirror 4 and the motor 8 which rotates the rotatable polygon mirror 4. The BD 6 as a detecting means detects, in order to determine a writing start position of the light beam L on the surface of the photosensitive drum 20, the light beam L deflected and scanned by the light deflector 5. The scanning lens 7 as image forming means forms an image of the light beam L, which is deflected and scanned, on the surface of the photosensitive drum 20. The scanning lens 7 is an example of at least one second lens through which the light beam deflected and scanned by the rotatable polygon mirror 4 is transmitted. In other words, the scanning optical device 101 includes one scanning lens 7 but may include a plurality of the scanning lenses. Modified Examples of the scanning optical device, which include two second lenses, are shown in FIG. 12 and subsequent Figures. Detailed description thereof will be given below.

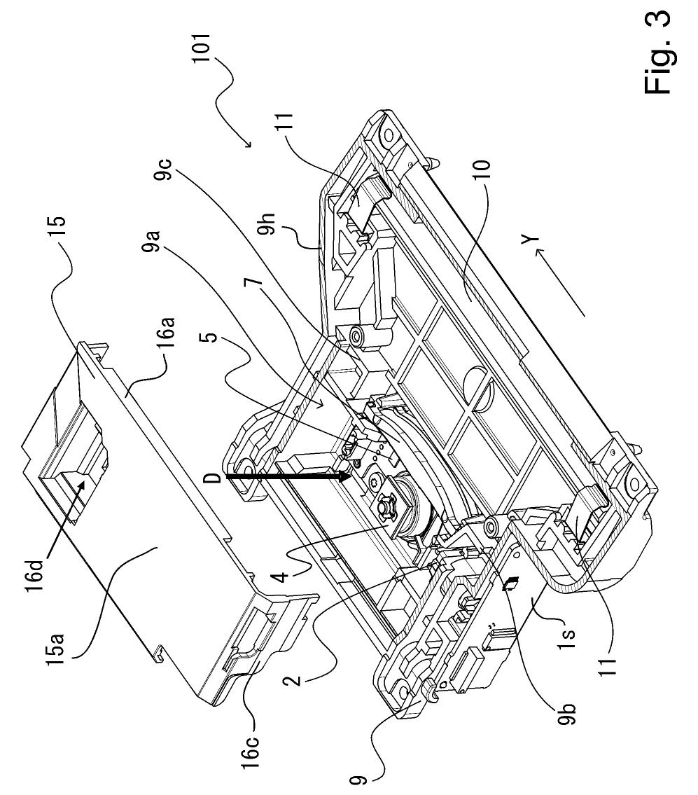

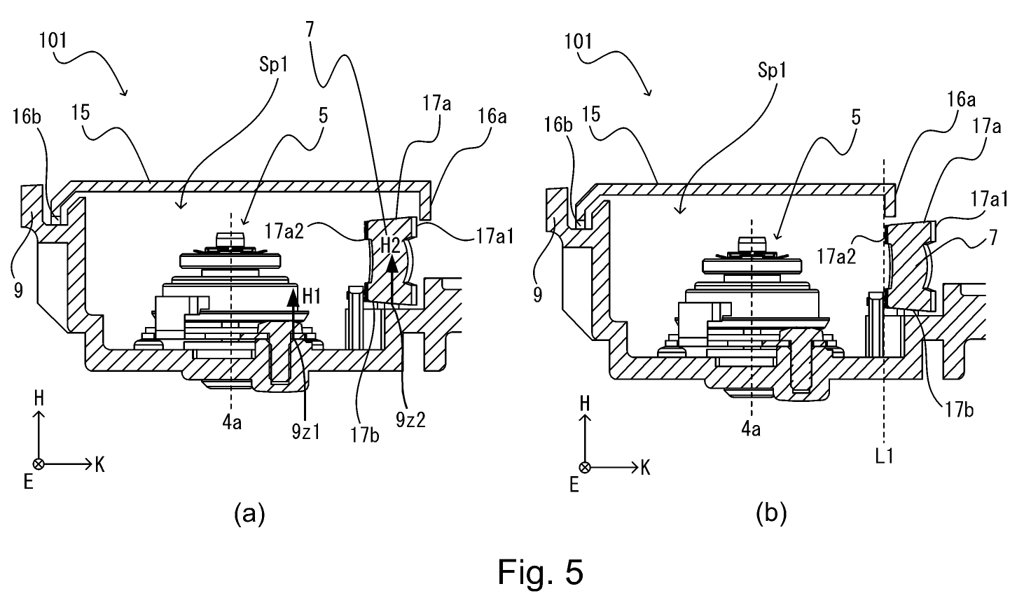

The reflecting mirror 10 reflects the light beam L transmitted through the scanning lens 7 toward the photosensitive drum 20. The reflecting mirror 10 is an example of a mirror which reflects the light beam transmitted from the second lens and guides the light beam to the scanned member. The optical box 9 as a casing accommodates each optical member including the light deflector 5. The optical box 9 is made of a black resin and is formed by injection molding. The optical box 9 is an example of a casing which includes a bottom surface on which the first lens, the rotatable polygon mirror, and at least one second lens are disposed, a slope on which the mirror is disposed, side surfaces standing upright from the bottom surface, and an opening (upper portion opening 9a (see FIG. 3)) formed by the side surfaces. Incidentally, in the bottom surface, not only a flat surface but also surfaces having different heights (having a height difference) (surfaces having irregularities and/or a stepped shape) are included. In a casing having a bottom surface with the height difference, for example, a position of the rotatable polygon mirror disposed on the bottom surface and a position of a lens similarly disposed on the bottom surface may be different from each other in a height direction (rotational axis direction of the rotatable polygon mirror 4). As shown in part (a) of FIG. 5, which will be described below, also in the optical box 9 in the Embodiment 1, the bottom surface is a surface having a height difference. In addition, as for the side surfaces as well, it is not necessarily limited to the configuration standing upright from the bottom surface, but a case in which the bottom surface and the side surface are continuous as a slope are also included.

The pressing spring 11 urges the reflecting mirror 10 toward the optical box 9. The pressing springs 11 urge the reflecting mirror 10 toward the optical box 9 at both ends in a longitudinal direction of the reflecting mirror 10 (which is also the Y direction). The two pressing springs 11 are examples of a first spring which presses one end of the mirror with respect to the longitudinal direction of the mirror and a second spring which presses the other end of the mirror. The emitting opening 13 is provided in the optical box 9, in more detail, is provided in a bottom portion (the bottom surface) of the optical box 9, and the light beam L in the optical box 9 is emitted from the emitting opening 13 to an outside of the optical box 9. The emitting opening 13 is an example of an emitting opening provided in the bottom surface and guides the light beam reflected by the mirror to the outside of the casing.

The rotatable polygon mirror 4 includes a plurality of reflecting surfaces 12, and in FIG. 2, includes four reflecting surfaces 12. A number of the reflecting surfaces 12 is not limited to four, but may be, for example, five. A direction in which the light beam L scans caused by the light deflector 5 is defined as a main scanning direction (which is also the Y direction), and a direction perpendicular to the main scanning direction is defined as a sub scanning direction, and operation of the scanning optical device 101 will be described below.

The light beam L emitted from the semiconductor laser unit 1 is made to be approximately parallel light or converged light in the main scanning direction, and is made to be converged light in the sub scanning direction by the anamorphic collimator lens 2. Next, in the light beam L, a luminous flux width in the main scanning direction is limited by the main scanning aperture 3. Incidentally, the luminous flux width in the sub scanning direction is limited by an opening hole (sub scanning aperture, not shown) located upstream of the anamorphic collimator lens 2. The luminous flux, which has passed through the sub scanning aperture, the anamorphic collimator lens 2, and the main scanning aperture 3, forms an image in a focal line shape extending long in the main scanning direction on the reflecting surface 12 of the rotatable polygon mirror 4.

The light beam L having formed the image on the reflecting surface 12 of the rotatable polygon mirror 4 is deflected and scanned by the rotatable polygon mirror 4 rotating in a direction of an arrow A. The light beam L deflected and scanned scans on the BD 6 in the main scanning direction. Next, the light beam L deflected and scanned enters the scanning lens 7. The light beam L having formed the image in the focal line shape on the reflecting surface 12 of the rotatable polygon mirror 4 is transmitted through the scanning lens 7, and on an emergent surface of the scanning lens 7, becomes a spot of approximately 2 mm in the main scanning direction and approximately 1.5 mm in the sub scanning direction. The light beam L transmitted through the scanning lens 7 is reflected by the reflecting mirror 10, and is emitted to the outside of the scanning optical device 101 through the emitting opening 13.

The emitted light beam L scans, while finally forming an image on the photosensitive drum 20, the photosensitive drum 20 in a direction of an arrow B in FIG. 2. Here, the sub scanning is performed by the photosensitive drum 20 being rotationally driven about an axis of a cylinder thereof. Through this operation, the electrostatic latent image corresponding to image information is formed on the surface of the photosensitive drum 20, which is uniformly charged by the charging roller 33 (shown in FIG. 1).

### Lid (cover)

Next, FIG. 3 is a perspective view illustrating a state in which a lid 15, which is a characteristic form in the Embodiment 1, is being assembled to the optical box 9. As shown by an arrow D in FIG. 3, the lid 15 is assembled so as to approximately obstruct a part of the upper opening 9a of the optical box 9 so as to cover the anamorphic collimator lens 2, the light deflector 5 including the rotatable polygon mirror 4, the scanning lens 7, etc. Incidentally, the arrow D is also a direction in which the light deflector 5, the scanning lens 7, and the reflecting mirror 10 are mounted to the optical box 9, and the mounting directions of these components to the optical box 9 are the same direction. The light deflector 5, the scanning lens 7, and the reflecting mirror 10 are mounted to the optical box 9 via the one opening 9a. The opening 9a is formed by edges 9h of the optical box 9 (indicated by hatching in FIG. 3).

The lid 15 is formed so as to cover a part of the optical box 9 in a K direction (see part (a) of FIG. 5 and part (b) of FIG. 5), which will be described below. A configuration of the lid 15 in the K direction will be described below. In a state in which the lid 15 is assembled to the optical box 9, the lid 15 forms, together with the optical box 9 and the scanning lens 7, an obstructed inner space Sp1 (see part (a) of FIG. 5 and part (b) of FIG. 5). The scanning optical device 101, to which the lid 15 is assembled, has a configuration which surrounds, with the scanning lens 7, the optical box 9, and the lid 15, the anamorphic collimator lens 2 and the light deflector 5 including the rotatable polygon mirror 4 inside.

When the rotatable polygon mirror 4 is rotated, a flow of air is generated. Due to the flow, air in a vicinity of the rotatable polygon mirror 4 flows out from the inner space Sp1, which is surrounded by the scanning lens 7, the optical box 9, and the lid 15, to an outside thereof through a gap, and outside air flows in through the gap. When the flowing in and the flowing out of air with the outside occur, dust floating with the outside air is taken into the optical box 9. By surrounding the light deflector 5 including the rotatable polygon mirror 4 with the scanning lens 7 and the optical box 9 and obstructing these with the lid 15, it becomes possible to reduce an amount of the outside air including dust reaching the rotatable polygon mirror 4. As a result, it becomes possible to reduce an amount of dust to be adhered to the rotatable polygon mirror 4.

Incidentally, to the optical box 9, wall portions 9b and 9c are provided so as to stand upright from the bottom surface. The wall portions 9b and 9c are provided at positions, in the Y direction, adjacent to both ends of the scanning lens 7. In the Y direction, since the wall portions 9b and 9c as a part of the optical box 9 are at the positions adjacent to both ends of the scanning lens 7, when the lid 15 is assembled to the optical box 9, it becomes possible to obstruct the inside also at both ends of the scanning lens 7. Incidentally, lengths of the wall portions 9b and 9c in the Y direction may be designed depending on a length of the scanning lens 7.

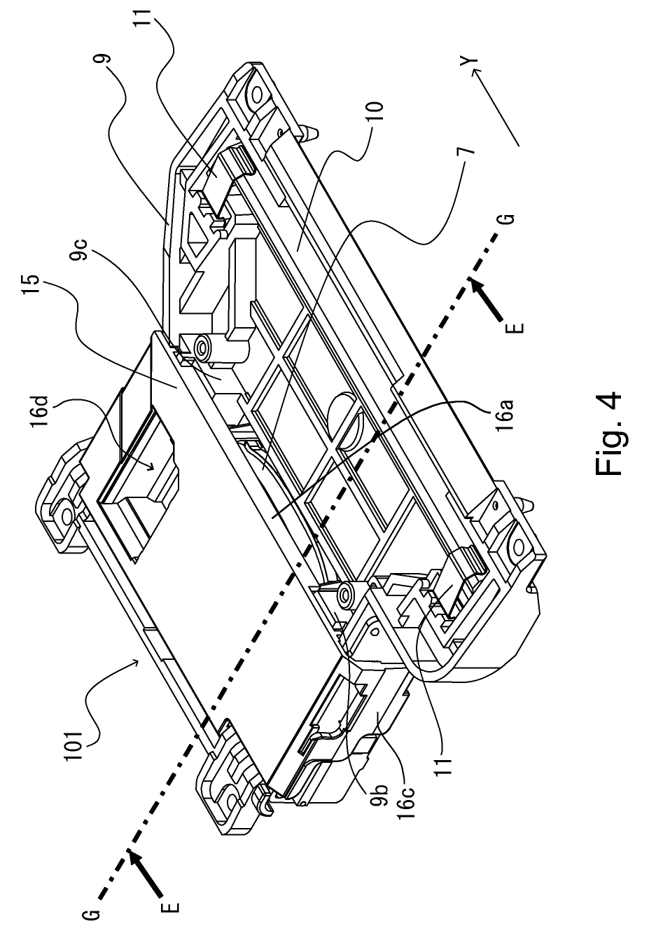

FIG. 4 is a perspective view illustrating the scanning optical device 101, to which the lid 15, which is a characteristic form in the Embodiment 1, is assembled. The reflecting mirror 10 and the pressing spring 11 are positioned outside the space surrounded by the scanning lens 7, the optical box 9, and the lid 15. Therefore, while the reflecting mirror 10 and the pressing spring 11 are attached to the optical box 9, the reflecting mirror 10 and the pressing spring 11 are not in the space obstructed by the lid 15. On the other hand, the anamorphic collimator lens 2 and the light deflector 5 are in the inner space Sp1 formed by the scanning lens 7, the optical box 9, and the lid 15. As shown in FIG. 4, by the scanning lens 7 and the wall portions 9b and 9c of the optical box 9, a part of the inner space Sp1 is obstructed. Incidentally, the lid 15 is fixed to the edges 9h of the optical box 9 with an adhesive. The lid 15 may be fixed to the optical box 9 by other means such as a snap-fitting and a screw. Incidentally, to the lid 15, a top surface (first part) 15a, an end (second part) 16a, a protecting portion 16c, which protects a substrate 1s, on which the semiconductor laser unit 1 is mounted, and a through hole 16d are provided.

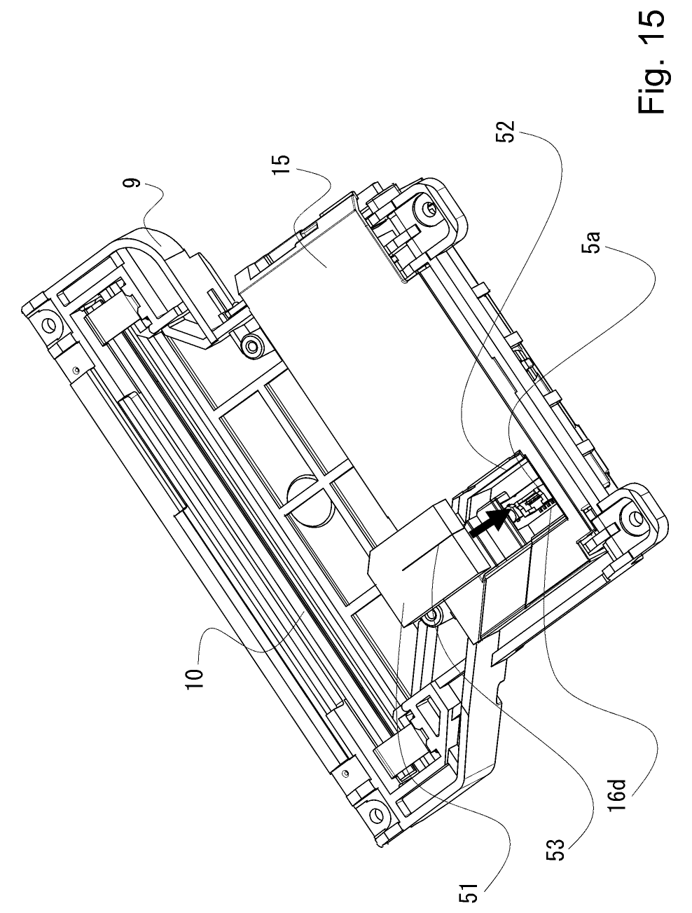

As shown in FIG. 15, to the light deflector 5, a connector 5a for connecting one end of an unshown harness is provided. The other end of the harness is connected to a control portion provided in the image forming apparatus 100, and a signal and electric power for driving the motor 8 are output from the control portion and supplied to the light deflector 5 via the harness. To the lid 15, in a vicinity of the connector 5a, the through hole 16d penetrating the lid 15 is provided, and even in a state in which the light deflector 5 is covered by the lid 15, it becomes possible to expose a portion in which the connector 5a is disposed. Therefore, in a state in which the lid 15 is attached to the optical box 9, it becomes possible to connect the end portion of the harness to the connector 5a. Incidentally, connectors are attached to both end portions of the harness, and between the connectors, a bundled wire in which a plurality of electric wires are bundled may be used, or one electric wire may be used.

In this manner, in the case in which the through hole 16d is provided in the lid 15, dust is likely to flow in from the through hole 16d. When the dust flows in, there is a possibility that the rotatable polygon mirror 4 is contaminated. Therefore, while the harness is kept connected to the connector 5a, so that the through hole 16d can be closed, an elastic member 51 which covers the through hole 16d is attached to the lid 15. As shown by an arrow in FIG. 15, the elastic member 51 is attached to a mounting portion 52, which has a recessed shape toward an inside of the optical box 9 provided in the lid 15. In a bottom surface portion of the mounting portion 52, the through hole 16d is provided. The elastic member 51 is a foamed material such as rubber and urethane, and in the elastic member 51, a cut portion 53 which forms a path for the harness is provided. Upon the elastic member 51 being attached to the mounting portion 52, the harness passes through the cut portion 53 of the elastic member 51. With this configuration, while the harness is kept connected to the connector 5a, the through hole 16d is closed by the elastic member 51, so that it becomes possible, while suppressing the flowing in of dust, to ensure the connection of the harness.

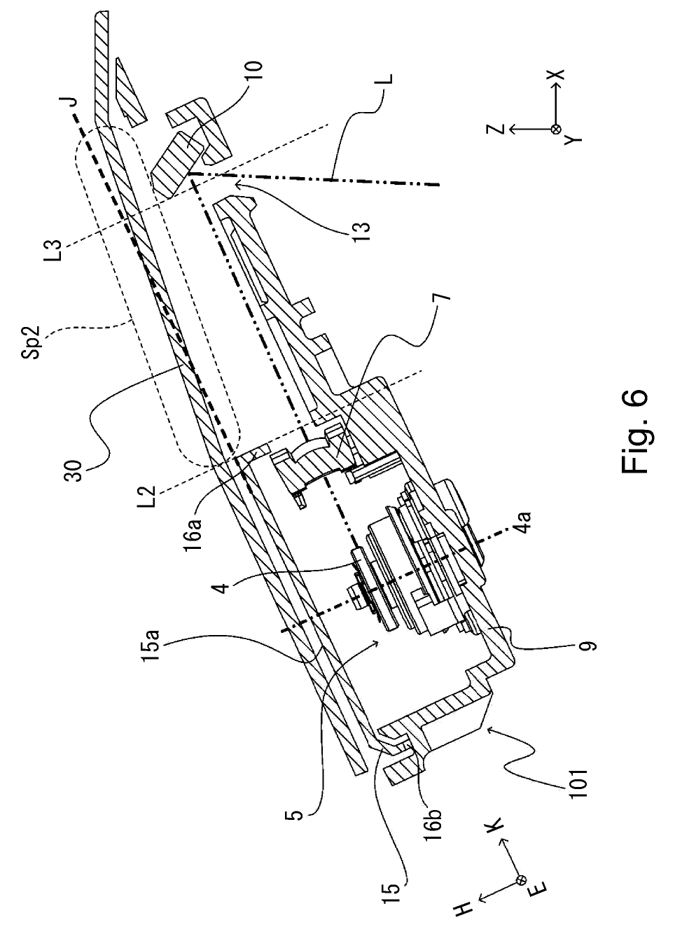

Part (a) of FIG. 5 and part (b) of FIG. 5 are G-G cross-sectional views of the scanning optical device 101 in the Embodiment 1, in which a cross section passing through a dash-dotted line shown in FIG. 4 is viewed in a direction of an arrow E. Incidentally, the direction of the arrow E (hereinafter, also simply referred to as an E direction) is also the Y direction. In addition, a rotation shaft of the rotatable polygon mirror 4 is defined as 4a, a direction parallel to the rotation shaft 4a is defined as an H direction, and a direction perpendicular to the E direction and the H direction is defined as the K direction. In the Embodiment 1, the H direction is inclined with respect to the Z direction, i.e., as viewed in the Y direction, the scanning optical device 101 is installed to the image forming apparatus 100 with inclined (see FIG. 1). Specifically, as viewed in the Y direction, the scanning optical device 101 is installed to the image forming apparatus 100 so that the rotatable polygon mirror 4 is at a lower position in the Z direction than the reflecting mirror 10 (see FIG. 1 and FIG. 6).

### On a length of the lid in the K direction

The lid 15 includes, as viewed in the E direction, the one end (second part) 16a close to the scanning lens 7 and the other end 16b. The end (second part) 16a of the lid 15 is a portion extending from the top surface (first part) 15a of the lid 15 in the rotational axis direction of the rotatable polygon mirror 4. The scanning lens 7 includes, as viewed in the E direction, a surface 17a (hereinafter, referred to as a top surface 17a) opposite to the lid 15 and a surface 17b in contact with the optical box 9. In addition, as viewed in the E direction, in the scanning lens 7, a portion which goes from an end of the top surface 17a on a farther side from the rotatable polygon mirror 4 toward the surface 17b is referred to as an outside 17a1 of the scanning lens 7. As viewed in the E direction, in the scanning lens 7, a portion which goes from an end of the top surface 17a on a closer side to the rotatable polygon mirror 4 toward the surface 17b is referred to as an inside 17a2 of the scanning lens 7. The optical box 9 includes a first seat surface 9z1 which holds the light deflector 5. In addition, the optical box 9 includes a second seat surface 9z2 with which the surface 17b is in contact (i.e., which holds the scanning lens 7). The second seat surface 9z2 is parallel to the first seat surface 9z1. A direction H1, which is a direction going from the first seat surface 9z1 toward the light deflector 5 and is perpendicular to the first seat surface 9z1, and a direction H2, which is a direction going from the second seat surface 9z2 toward the scanning lens 7 and is perpendicular to the second seat surface 9z2, are the same direction.

In the Embodiment 1, as shown in part (a) of FIG. 5, as viewed in the E direction, the end 16a of the lid 15 covers up to the outside 17a1 of the scanning lens 7. However, the end 16a of the lid 15 does not necessarily need to cover up to the outside 17a1. For example, as shown in part (b) of FIG. 5, the end 16a of the lid 15 reaches up to an upper portion of the top surface 17a of the scanning lens 7, in other words, it is sufficient that the end 16a of the lid 15 is not closer to the rotatable polygon mirror 4 than the inside 17a2 of the scanning lens 7. Specifically, it is sufficient that the end 16a of the lid 15 is not closer to the rotatable polygon mirror 4 than an imaginary line L1. Here, as viewed in the E direction, the imaginary line L1 is a line passing through a point in the inside 17a2 of the scanning lens 7 closest to the rotatable polygon mirror 4. In other words, it is sufficient that the light deflector 5 can be approximately obstructed by the lid 15.

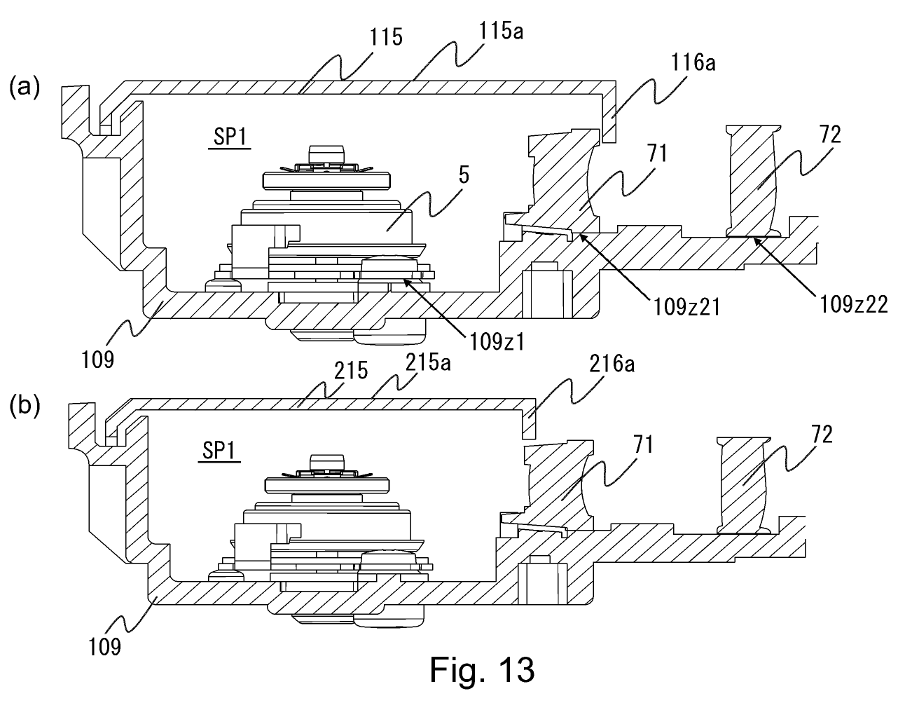

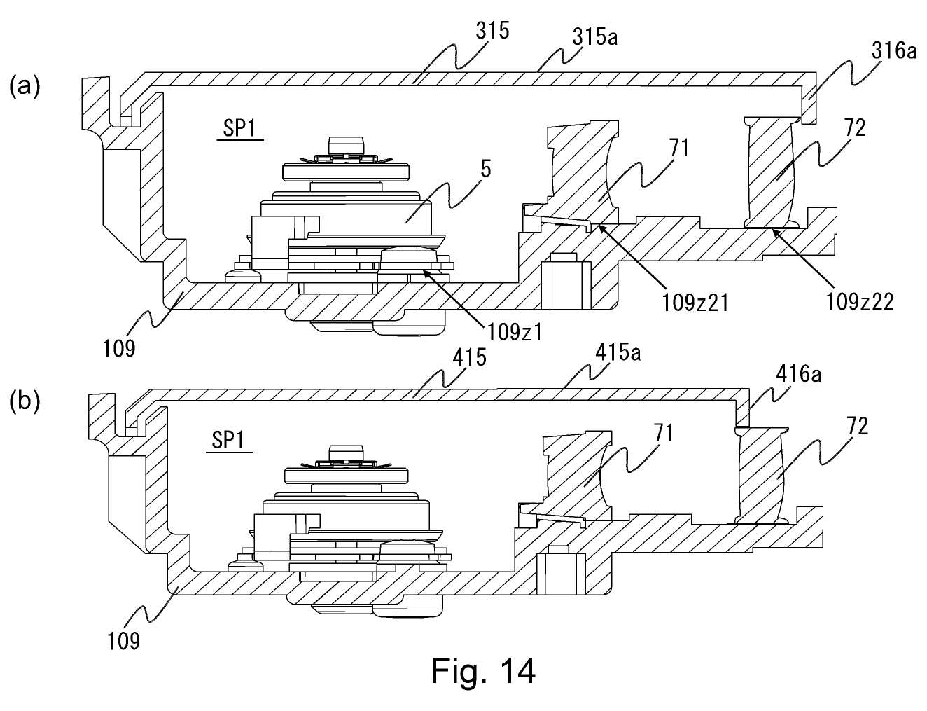

FIG. 12, part (a) and part (b) of FIG. 13, and part (a) and part (b) of FIG. 14 show a scanning optical device 1101, which is a Modified Example of the Embodiment 1 and to which two scanning lenses (a scanning lens 71 and a scanning lens 72) are provided. As shown in part (a) of FIG. 13, the scanning lens 71 is attached to a seat surface 109z21 of an optical box 109, and the scanning lens 72 is attached to a seat surface 109z22 of the optical box 109.

Next, a specific form preferable for the case in which the two scanning lenses 71 and 72 are provided will be described. As shown in part (a) of FIG. 13, an inner space SP1 is formed when an end (second part) 116a, which extends from a top surface (first part) 115a of a lid 115 in a rotational axis direction of a rotatable polygon mirror, and a side of a light beam emergent surface of the scanning lens 71 get close to each other. In addition, as shown in part (b) of FIG. 13, an inner space SP1 is formed when an end (second part) 216a extending from a top surface (first part) 215a of a lid 215 in a rotational axis direction of a rotatable polygon mirror and a top surface of the scanning lens 71 get close to each other. As shown in part (a) of FIG. 14, an inner space SP1 is formed when an end (second part) 316a extending from a top surface (first part) 315a of a lid 315 in a rotational axis direction of a rotatable polygon mirror and a side of a light beam emergent surface of the scanning lens 72 get close to each other. In addition, as shown in part (b) of FIG. 14, an inner space SP1 is formed when an end (second part) 416a extending from a top surface (first part) 415a of a lid 415 in a rotational axis direction of a rotatable polygon mirror and a top surface of the scanning lens 72 get close to each other.

In the Embodiment 1, by obstructing the light deflector 5 surrounded by the optical box 9 and the scanning lens 7 with the lid 15 of a minimum size, it becomes possible to prevent the dust contained in air from entering into the vicinity of the rotatable polygon mirror 4 as much as possible. As a result, it becomes possible, while reducing the amount of dust to be adhered to the rotatable polygon mirror 4, to realize downsizing of the lid 15.

### Positional relationship between the scanning optical device and the discharge tray

FIG. 6 is a cross-sectional view illustrating a positional relationship between the scanning optical device 101 and the discharge tray 30 in the Embodiment 1. As shown in FIG. 6, the discharge tray 30 is positioned at an upper portion of the scanning optical device 101, and is held by components other than the scanning optical device 101, which are not shown. For ease of understanding, an imaginary line obtained by extending the top surface (first part) 15a of the lid 15 is shown as J (hereinafter, referred to as an imaginary line J). The imaginary line J is perpendicular to the rotation shaft 4a of the rotatable polygon mirror 4, in other words, the H direction. Since a space between the scanning lens 7 and the reflecting mirror 10 is not covered by the lid 15, the discharge tray 30 can be brought closer, between the scanning lens 7 and the reflecting mirror 10, in the H direction, to the light beam L than the imaginary line J passing through the top surface 15a of the lid 15. In other words, the discharge tray 30 can be brought closer, in a space closer to the reflecting mirror 10 than an imaginary line L2 passing through an outer surface of the end (second part) 16a of the lid 15, to the light beam L than the imaginary line J.

An upper space Sp2 (indicated by a broken line in FIG. 6) between the scanning lens 7 and the reflecting mirror 10, which is resulted by the downsizing of the lid 15, may improve a degree of freedom in designing a main cross section in the image forming apparatus 100 (see FIG. 1) around the scanning optical device 101. In particular, by disposing the discharge tray 30, which affects a height of an apparatus main assembly (in the Z direction), in the space Sp2, it becomes possible to reduce the height (a length in the Z direction) of the image forming apparatus 100, and consequently, to realize the downsizing of the image forming apparatus 100.

In the Embodiment 1, by obstructing the light deflector 5 with the lid 15 of the minimum size described above, it becomes possible, while reducing the amount of dust to be adhered to the rotatable polygon mirror 4, to realize the downsizing of the lid 15. Furthermore, by effectively utilizing the upper space Sp2 between the scanning lens 7 and the reflecting mirror 10, it becomes possible to realize cost reduction through the downsizing of the image forming apparatus 100.

Incidentally, it is sufficient that the space Sp2 between the scanning lens 7 and the reflecting mirror 10 resulted by the downsizing of the lid 15 is effectively used for disposition of components of the image forming apparatus 100, and a position and a posture of the scanning optical device 101 in the apparatus main assembly of the image forming apparatus are not limited. For example, the H direction may coincide with the Z direction, in other words, it is not necessary for the scanning optical device 101 to be installed with inclined to the image forming apparatus 100.

As described above, according to the Embodiment 1, it becomes possible, while ensuring the accuracy of irradiating position of the light beam, to provide the scanning optical device which realizes the downsizing and the cost reduction thereof.

### Embodiment 2

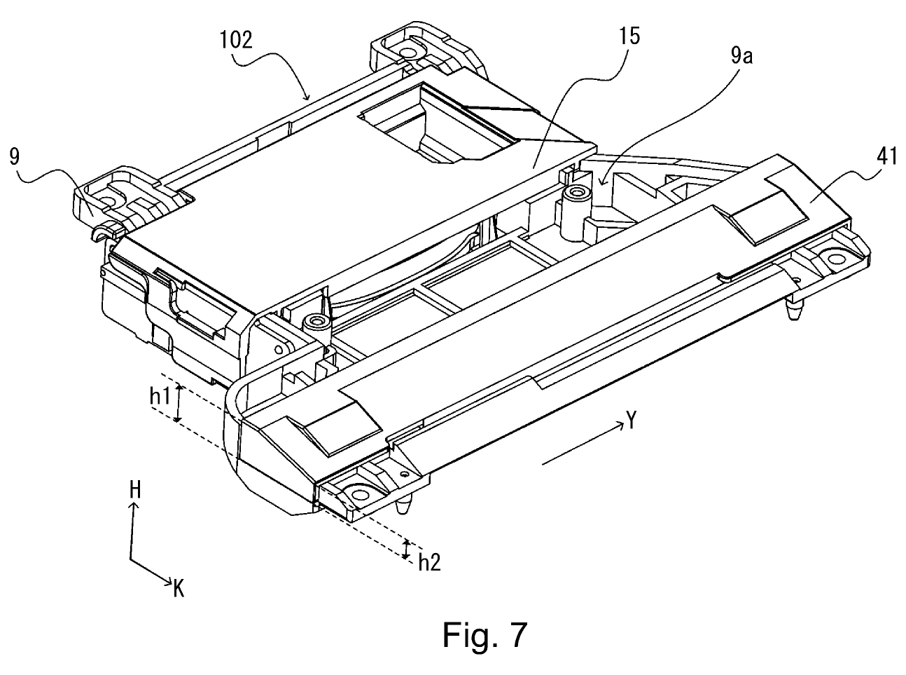

FIG. 7 is a perspective view illustrating a scanning optical device 102 in an Embodiment 2. The scanning optical device 102 is a form in which a mirror cover 41 is added to the scanning optical device 101 in the Embodiment 1. Since constituent components other than portions described below are the same as those in the Embodiment 1, the same reference numerals will be attached thereto and description thereof will be omitted. The configuration of the lid 15 is also the same as in the Embodiment 1.

As shown in FIG. 7, the scanning optical device 102 is provided with the mirror cover 41. The mirror cover 41 covers a reflecting mirror 10 and pressing springs 11 shown in FIG. 2. In more detail, the mirror cover 41 is formed so as to cover, in a Y direction, an entire area of an optical box 9 (the reflecting mirror 10). The mirror cover 41 is formed so as to cover, in a K direction, a part of the optical box 9, specifically the reflecting mirror 10 and the pressing springs 11. Specifically, in the K direction, in a direction away from a rotatable polygon mirror 4, it is sufficient that at least an area from an imaginary line L3 (see FIG. 6) including the reflecting mirror 10 and the pressing springs 11 can be covered. Here, as viewed in an E direction, the imaginary line L3 is a line which passes through a portion, in an outer edge of the reflecting mirror 10, closest to the rotatable polygon mirror 4 and is parallel to an H direction. The mirror cover 41 is an example, when the lid 15 is referred to as a first lid, of a second lid which covers the mirror, the first spring, and the second spring.

Furthermore, as viewed in the E (Y) direction, a height h1 is defined as a length in the H direction of an end of the mirror cover 41 on a closer side to a scanning lens 7, and a height h2 is defined as a length in the H direction of an end of the mirror cover 41 on a farther side from the scanning lens 7. In this case, the height h2 is lower than the height h1 (h1 > h2). Therefore, as viewed in the E (Y) direction, the mirror cover 41 is inclined in a direction going from the scanning lens 7 toward the reflecting mirror 10, and gets closer to a light beam L than the imaginary line J in FIG. 6.

In the Embodiment 2, the lid 15 and the mirror cover 41 cover an upper opening 9a of the optical box 9 in a state in which a part of the upper opening 9a of the optical box 9 is open. Compared with a case in which the entire upper opening 9a is approximately obstructed by the lid with the configuration in the Embodiment 2, it becomes possible to cover members in the optical box 9 with a minimum required amount, and it becomes possible to reduce material for the uncovered portion between the lid 15 and the mirror cover 41.

By covering the reflecting mirror 10 and the pressing springs 11 shown in FIG. 2 with the mirror cover 41, it becomes possible, upon a worker assembles the scanning optical device 102 to an image forming apparatus 100, to prevent the worker from unintentionally coming into contact with the reflecting mirror 10 and/or the pressing springs 11, and to prevent a posture of the reflecting mirror 10 from being misaligned. As a result, since it becomes possible to prevent an irradiating position of a spot on a photosensitive drum 20 from being misaligned due to the misalignment of the posture of the reflecting mirror 10, it becomes possible to reduce risk of deterioration in optical performance during assembly.

### Embodiment 3

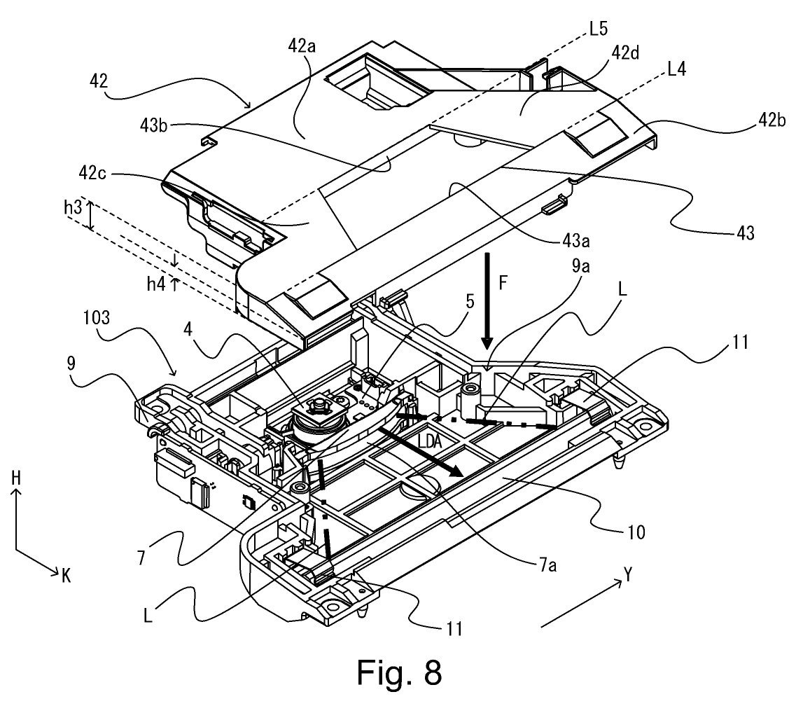

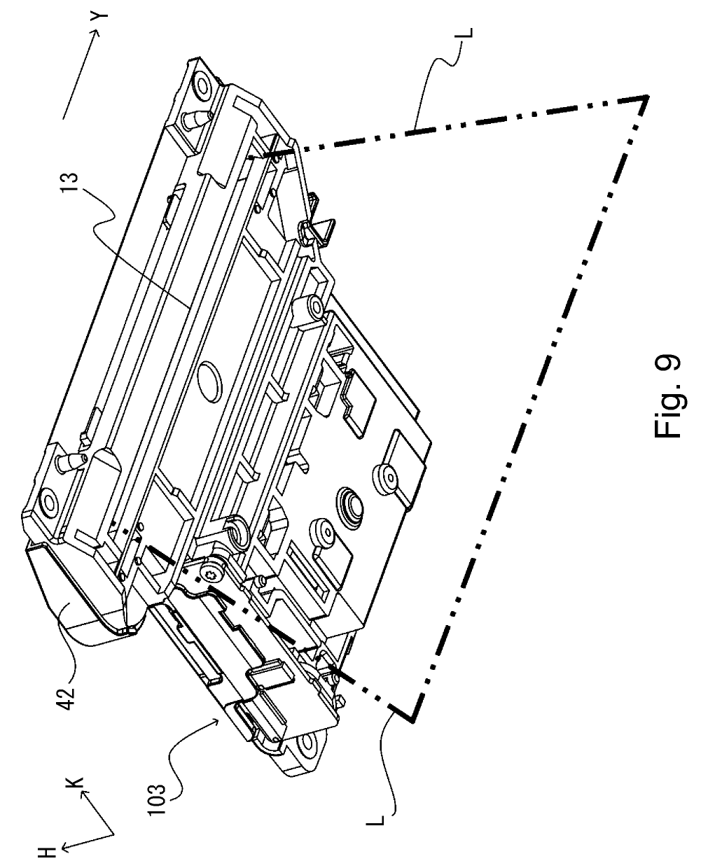

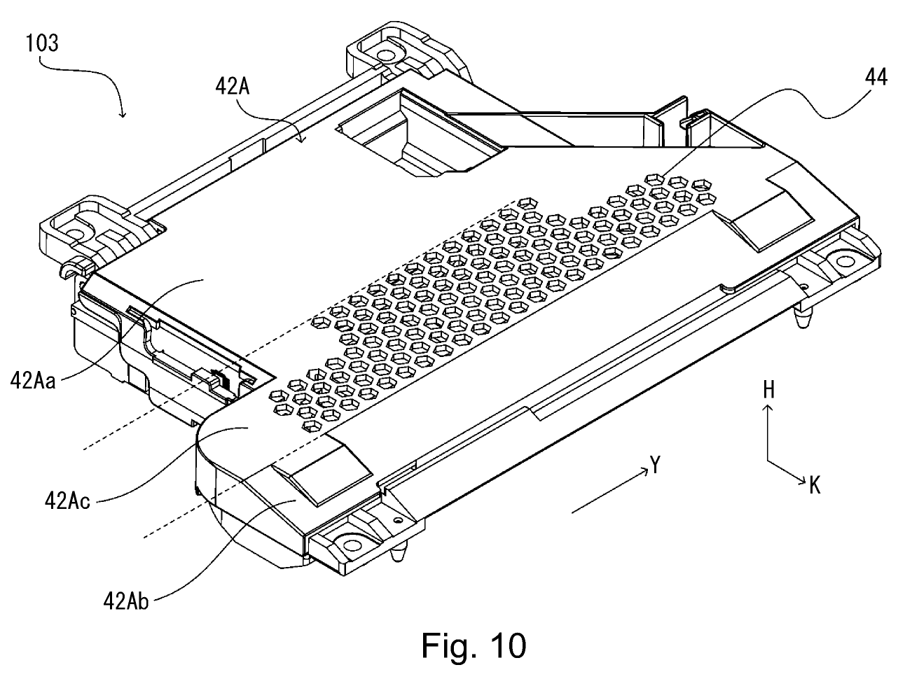

A scanning optical device 103 in an Embodiment 3 will be described using FIG. 8, FIG. 9, and FIG. 10. The scanning optical device 103 is a form in which a lid 42 is assembled thereto instead of the lid 15 of the scanning optical device 101 in the Embodiment 1. Since constituent components other than portions described below are the same as those in the Embodiment 1, the same reference numerals will be attached thereto and description thereof will be omitted.

### Lid (cover)

FIG. 8 is a perspective view illustrating a state in which, in the scanning optical device 103 in the Embodiment 3, the lid 42 is being assembled. As shown in FIG. 8, the lid 42 includes an opening hole 43. The opening hole 43 is provided between an emergent surface 7a of a scanning lens 7, which is a side from which a light beam L is emitted, and a reflecting mirror 10. In addition, an opening area of the opening hole 43 (area of a second opening) is larger than an opening area of an emitting opening 13 (see FIG. 2). As viewed in an E (Y) direction, it is sufficient that the opening hole 43 is provided between an imaginary line L2 and an imaginary line L3 shown in FIG. 6. Incidentally, an arrow LDA shown in FIG. 8 is an optical axis direction of the light beam L passing through the scanning lens 7 and is an advancing direction of the light beam L passing through the scanning lens 7.

As indicated by an arrow F, the lid 42 is assembled so as to cover an upper opening 9a of an optical box 9. Similarly to the Embodiment 1, the upper opening 9a of a light deflector 5 surrounded by the optical box 9 and the scanning lens 7 is approximately obstructed by the lid 42. In addition, similarly to the mirror cover 41 in the Embodiment 2, the lid 42 covers a reflecting mirror 10 and pressing springs 11. In the K direction, it is configured that the lid 42 has a length capable of covering not only the light deflector 5 and the scanning lens 7 but also the reflecting mirror 10 and the pressing springs 11.

Here, as shown in FIG. 8, among sides forming the opening hole 43, an imaginary line obtained by extending a side 43a farthest from the scanning lens 7, in other words, closest to the reflecting mirror 10, in a Y direction is defined as L4. As viewed from the E (Y) direction, a length in an H direction at a position where the imaginary line L4 passes through is defined as a height h3, and a height h4 is defined as a length in the H direction of an end of the lid 42 on a further side from the scanning lens 7. In this case, the height h4 is lower than the height h3 (h3 > h4). Therefore, as viewed in the E direction, on a side closer to the reflecting mirror 10 than the side 43a, the lid 42 is inclined in a direction going from the scanning lens 7 toward the reflecting mirror 10, and gets closer to the light beam L than an imaginary line J in FIG. 6.

In addition, as shown in FIG. 8, among the sides forming the opening hole 43, an imaginary line obtained by extending a side 43b closest to the scanning lens 7, in other words, farthest from the reflecting mirror 10, in the Y direction is defined as L5. In this case, in the lid 42, a portion in a direction going from the imaginary line L5 toward the rotatable polygon mirror 4 is defined as a first part 42a. The first part 42a is an example of a first part which covers the first lens, the rotatable polygon mirror, and the second lens. In addition, in the lid 42, a portion in a direction going away from the rotatable polygon mirror 4 from the imaginary line L4 is defined as a third part 42b. The third part 42b is an example of a third part which covers the mirror, the first spring, and the second spring. Furthermore, as shown in FIG. 8, the first part 42a and the third part 42b are connected by connecting portions 42c and 42d. In other words, these are examples of facts that, in a longitudinal direction (the Y direction) of the lid 42, one end of the first part and one end of the third part are connected, and the other end of the first part and the other end of the third part are connected. The first part 42a and the third part 42b of the lid 42 are formed so as to cover, in the Y direction, an entire area of the optical box 9.

FIG. 9 is a perspective view of the scanning optical device 103 in the Embodiment 3 as viewed from a side of the emitting opening 13 (see FIG. 2). The scanning optical device 103 emits the light beam L to an outside of the scanning optical device 103 through the emitting opening 13.

Next, using FIG. 8 and FIG. 9, an influence of the opening hole 43, which is a characteristic form in the Embodiment 3, on air flowing in and flowing out with respect to the scanning optical device 103 will be described. By providing the opening hole 43 shown in FIG. 8, a large opening portion of the scanning optical device 103 becomes the emitting opening 13 and the opening hole 43. The flowing in and flowing out of air with respect to the scanning optical device 103 occur due to the rotation of the rotatable polygon mirror 4, however, these mainly flow in or flow out through the opening hole 43 close to the rotatable polygon mirror 4. As a result, flowing in and flowing out of air through the emitting opening 13 are reduced, so that it becomes possible to reduce an amount of dust to be adhered to the reflecting mirror 10, which is disposed in a vicinity of the emitting opening 13.

On the other hand, by providing the opening hole 43, there is a possibility that dust in the air is adhered to the scanning lens 7. However, since the scanning lens 7 forms an image of the light beam on a surface of a photosensitive drum 20 (shown in FIG. 2), an area of a spot of the light beam L decreases since as it goes from the scanning lens 7 to the photosensitive drum 20 (shown in FIG. 2), a diameter of the spot decreases. For example, in the Embodiment 3, while the area of the spot of the light beam L immediately after being transmitted through the scanning lens 7 is approximately 3 mm², the area of the spot of the light beam L on the reflecting mirror 10 is approximately 1 mm². Even if dusts having the same size are adhered to the scanning lens 7 and the reflecting mirror 10, a local decreased amount of light amount of the scanning lens 7 becomes approximately one-third compared with that of the reflecting mirror 10, so that it may be said that at the scanning lens 7, it is less likely for the local decrease of the light amount due to the dust to occur. Incidentally, the values of the area of the spot of the light beam L and the relative value thereof (such as 3 mm² and one-third) described above are examples, and as the value of the area of the spot of the light beam L in each optical member gets larger, the local decrease of the light amount due to the dust becomes less likely to occur. Therefore, even when the opening hole 43 is provided, dustproof performance of the scanning optical device 103 can be ensured.

In the Embodiment 3, it becomes possible, while ensuring the dustproof performance of the scanning optical device 103, to reduce material for the lid 42. In addition, similarly to the Embodiment 2, by covering the reflecting mirror 10 and the pressing springs 11 shown in FIG. 2, it becomes possible to prevent a worker from coming into contact with the reflecting mirror 10 and/or the pressing springs 11, and to prevent a posture of the reflecting mirror 10 from being misaligned. Furthermore, by configuring the opening area of the opening hole 43 to be larger than the opening area of the emitting opening 13, it becomes possible to securely reduce an amount of air flowing in and flowing out through the emitting opening 13, so that it becomes possible to reduce the amount of dust to be adhered to the reflecting mirror 10.

### Modified Example

Incidentally, the opening hole 43 is provided in the Embodiment 3, however, as shown in FIG. 10, the opening hole 43 may be formed of a large number of small holes 44. A lid in a Modified Example of the Embodiment 3 is referred to as a lid 42A. It is sufficient that the plurality of small holes 44 are provided, in a K direction, between an imaginary line L2 and an imaginary line L3 shown in FIG. 6. In addition, a total opening area (total area) of the plurality of small holes 44 is larger than an opening area of an emitting opening 13. In the lid 42A, a first part 42Aa is an example of a first part which covers a first lens, a rotatable polygon mirror, and a second lens. A third part 42Ab is an example of a third part which covers a mirror, a first spring, and a second spring. A fourth part 42Ac is an example of a fourth part which connects the first part and the third part, and includes the plurality of through holes.

In the case of the opening hole 43, if the opening area thereof is increased to a certain extent or more, vibration of the lid is increased due to a reduction in rigidity of the lid, and there is a possibility that noise and misalignment of the irradiating position of the light beam L occur. On the other hand, by forming the opening hole 43 with the large number of small holes 44, it becomes possible to keep the rigidity of the lid high. Therefore, even if the small holes 44 are formed over a wider range, it becomes possible to suppress the reduction in the rigidity of the lid, so that it becomes possible to prevent that the noise and the misalignment of irradiating position of the light beam L occur. By forming the opening with the large number of small holes 44, it becomes possible to dispose the small holes 44 at optimal positions according to a shape of the lid 42 and reduce material cost.

### Shape of the small hole

In FIG. 10, the small holes 44 are configured to be all regular hexagons having the same size, however, the shape of the small hole 44 is not limited thereto, but may be, for example, a circle or another polygon. In addition, the respective shapes and sizes of the small holes 44 may be different from each other.

### Embodiment 4

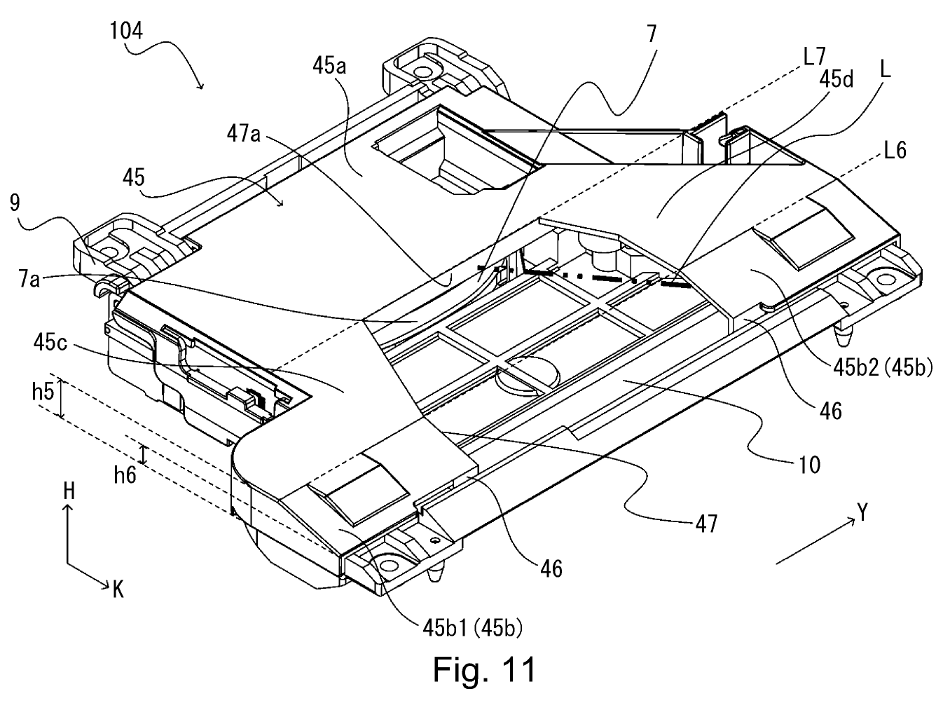

FIG. 11 is a perspective view illustrating a scanning optical device 104 in an Embodiment 4. The scanning optical device 104 is a form in which a lid 45 is assembled thereto instead of the lid 15 of the scanning optical device 101 in the Embodiment 1. Since constituent components other than portions described below are the same as those in the Embodiment 1, the same reference numerals will be attached thereto and description thereof will be omitted.

In the lid 45, a cutout portion 47 reaching from an emergent surface 7a of a light beam L of a scanning lens 7 to an end 46 on a reflecting mirror 10 side is provided. In a Y direction, it is sufficient that the lid 45 at least covers pressing springs 11 at both ends of the reflecting mirror 10 in the Y direction.

Here, as shown in FIG. 11, an imaginary line, which is parallel to the Y direction at a predetermined position at least closer to the scanning lens 7 than the reflecting mirror 10 in a portion in which the cutout portion 47 is provided, is defined as an imaginary line L6. In addition, as shown in FIG. 11, among sides forming the cutout portion 47, an imaginary line obtained by extending a side 47a closest to the scanning lens 7, in other words, farthest from the reflecting mirror 10, in the Y direction is defined as an imaginary line L7. In this case, in the lid 45, a portion in a direction going from the imaginary line L7 toward a rotatable polygon mirror 4 is defined as a first part 45a. The first part 45a is an example of a first part which covers the first lens, the rotatable polygon mirror, and the second lens. In addition, in the lid 45, a portion in a direction going away from the rotatable polygon mirror 4 from the imaginary line L6 is defined as a third part 45b. The third part 45b is an example of a third part which covers the mirror, the first spring, and the second spring. Furthermore, as shown in FIG. 11, the first part 45a and the third part 45b are connected by connecting portions 45c and 45d. In other words, these are examples of facts that, in a longitudinal direction (the Y direction), one end of the first part and one end of the third part are connected, and the other end of the first part and the other end of the third part are connected.

In the Embodiment 4, since the lid 45 includes the cutout portion 47, the third part 45b does not cover at least a part of the reflecting mirror 10 (specifically, a central portion in the Y direction). The third part 45b is separated into a part 45b1, which covers the reflecting mirror 10 and the pressing spring 11 at one end in the longitudinal direction of the reflecting mirror 10, and a part 45b2, which covers the reflecting mirror 10 and the pressing spring 11 at the other end.

Incidentally, the third part 45b (45b1, 45b2) and the connecting portions 45c and 45d in FIG. 11 may also be regarded as a third part corresponding to the first part of the lid 45. In this case, it can also be said that the lid 45 includes the third part, which is continuous from the first part and covers the first spring and the second spring, and the cutout portion provided so that the part of the mirror is not covered. In addition, an area of the cutout portion is larger than an area of an emitting opening 13.

As viewed from an E (Y) direction, a length in an H direction at a position where the imaginary line L6 passes through is defined as a height h5, and a height h6 is defined as a length in the H direction of an end of the lid 45 on a further side from the scanning lens 7. In this case, the height h6 is lower than the height h5 (h5 > h6). Therefore, as viewed in the E direction, the lid 45 is inclined, on a side closer to the reflecting mirror 10 than the imaginary line L6, in a direction going from the scanning lens 7 toward the reflecting mirror 10, and gets closer to the light beam L than an imaginary line J in FIG. 6.

Similarly to the Embodiment 1, an upper opening 9a of a light deflector 5 (shown in FIG. 2) surrounded by an optical box 9 and the scanning lens 7 is approximately obstructed by the lid 45 (first part 45a). In addition, the pressing springs 11 (shown in FIG. 2) are covered by the lid 45 (third part 45b).

In the Embodiment 4, by providing the cutout portion 47, it becomes possible to obtain an effect similar to that of the opening hole 43 described in the Embodiment 3, so that it becomes possible to ensure the dustproof performance as the scanning optical device 104. In addition, by covering the pressing spring 11 with the lid 45, similarly to the Embodiment 2, it becomes possible to reduce, upon the scanning optical device 104 being assembled to the image forming apparatus 100, the deterioration in optical performance. And further, it becomes possible to reduce material for the lid 45.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2025-032908, filed March 3, 2025 and 2025-272208, filed December 22, 2025, which are hereby incorporated by reference herein in their entirety.

What is claimed is:

1. A scanning optical device for scanning a scanned member with a light beam depending on image information; the scanning optical device comprising:
a first lens through which the light beam emitted from a light source is transmitted;
a light deflector including a rotatable polygon mirror for deflecting and scanning the light beam transmitted from the first lens;
a second lens through which the light beam deflected and scanned by the light deflector is transmitted;
a mirror configured to reflect the light beam transmitted from the second lens and to guide to the scanned member;
a casing configured to hold the first lens, the light deflector, the second lens and the mirror, the casing including an edge portion for forming an opening through which the first lens, the light deflector, the second lens and the mirror are mounted on the casing; and
a lid configured to cover a part of the opening,
wherein a direction from a first seat surface, of the casing, which holds the light deflector and toward the light deflector and perpendicular to the first seat surface, and a direction from a second seat surface, of the casing, which holds the second lens and is parallel to the first seat surface toward the second lens held by the second seat surface and perpendicular to the second seat surface are the same direction,
wherein as the scanning optical device is viewed in a rotational axis direction of the rotatable polygon mirror from a side of the lid, the lid does not cover the mirror but covers the first lens and the rotatable polygon mirror, and
wherein in a state in which the part of the opening is covered by the lid, the first lens and the rotatable polygon mirror are in a space formed and obstructed by the lid, the casing and the second lens held by the second seat surface.

2. The scanning optical device according to claim 1, wherein as viewed in a longitudinal direction of the second lens and perpendicular to a rotational axis direction of the rotatable polygon mirror, the lid includes a first part parallel to the first seat surface and a second part extending from the first part to the rotational axis direction, and
wherein the space is formed by the second part of the lid and the second lens being close to each other.

3. An image forming apparatus comprising:
the scanning optical device according to claim 2;
the scanned member on which an electrostatic latent image is formed by the scanning optical device;
a developing portion configured to develop the electrostatic latent image with toner and to form a toner image;
a transfer portion configured to transfer the toner image to a recording material; and
a fixing portion configured to fix the toner image, transferred by the transfer portion, onto the recording material.

4. The image forming apparatus according to claim 3, further comprising a discharge tray configured to receive the recording material on which the toner image is fixed and which is discharged outside the image forming apparatus,
wherein as viewed in a longitudinal direction of the mirror, an imaginary line extending a top surface of the lid from the second lens toward the mirror is defined as a first imaginary line, a part of the discharge tray is disposed below the first imaginary line at least between the second lens closest to the rotatable polygon mirror and the mirror.

5. A scanning optical device for scanning a scanned member with a light beam depending on image information; the scanning optical device comprising:
a first lens through which the light beam emitted from a light source is transmitted;
a light deflector including a rotatable polygon mirror for deflecting and scanning the light beam transmitted from the first lens;
a second lens through which the light beam deflected and scanned by the light deflector is transmitted;
a mirror configured to reflect the light beam transmitted from the second lens and to guide to the scanned member;
a casing configured to hold the first lens, the light deflector, the second lens and the mirror, the casing including an edge portion for forming an opening through which the first lens, the light deflector, the second lens and the mirror are mounted on the casing;
a first spring configured to urge one end of the mirror to the casing with respect to a longitudinal direction of the mirror and a second spring configured to urge the other end of the mirror to the casing;
a first lid configured to cover a part of the opening; and
a second lid configured to cover the mirror, the first spring and the second spring,
wherein a direction from a first seat surface, of the casing, which holds the light deflector and toward the light deflector and perpendicular to the first seat surface, and a direction from a second seat surface, of the casing, which holds the second lens and is parallel to the first seat surface toward the second lens held by the second seat surface and perpendicular to the second seat surface are the same direction,
wherein as the scanning optical device is viewed in a rotational axis direction of the rotatable polygon mirror from a side of the first lid, the first lid does not cover the mirror and covers the first lens and the rotatable polygon mirror, and
wherein in a state in which the part of the opening is covered by the first lid, the first lens and the rotatable polygon mirror are in a space formed and obstructed by the first lid, the casing and the second lens held by the second seat surface.

6. The scanning optical device according to claim 5, wherein as viewed in a longitudinal direction of the second lens and perpendicular to the rotational axis direction of the rotatable polygon mirror, the first lid includes a first part parallel to the first seat surface and a second part extending from the first part to the rotational axis direction, and
wherein the space is formed by the second part of the first lid and the second lens being close to each other.

7. An image forming apparatus comprising:
the scanning optical device according to claim 6;
the scanned member on which an electrostatic latent image is formed by the scanning optical device;
a developing portion configured to develop the electrostatic latent image with toner and to form a toner image;
a transfer portion configured to transfer the toner image to a recording material; and
a fixing portion configured to fix the toner image, transferred by the transfer portion, onto the recording material.

8. The image forming apparatus according to claim 7, further comprising a discharge tray configured to receive the recording material on which the toner image is fixed and which is discharged outside the image forming apparatus,
wherein when as viewed in a longitudinal direction of the mirror, an imaginary line extending a top surface of the first lid from the second lens toward the mirror is defined as a first imaginary line, a part of the discharge tray is disposed below the first imaginary line at least between the second lens closest to the rotatable polygon mirror and the mirror.

9. A scanning optical device for scanning a scanned member with a light beam depending on image information; the scanning optical device comprising:
a first lens through which the light beam emitted from a light source is transmitted;
a light deflector including a rotatable polygon mirror for deflecting and scanning the light beam transmitted from the first lens;
a second lens through which the light beam deflected and scanned by the light deflector is transmitted;
a mirror configured to reflect the light beam transmitted from the second lens and to guide to the scanned member;
a casing configured to hold the first lens, the light deflector, the second lens and the mirror, the casing including an edge portion for forming an opening through which the first lens, the light deflector, the second lens and the mirror are mounted on the casing;
a first spring configured to urge one end of the mirror to the casing with respect to a longitudinal direction of the mirror and a second spring configured to urge another end of the mirror to the casing; and
a lid configured to cover a part of the opening,
wherein a direction from a first seat surface, of the casing, which holds the light deflector and toward the light deflector and perpendicular to the first seat surface, and a direction from a second seat surface, of the casing, which holds the second lens and is parallel to the first seat surface toward the second lens held by the second seat surface and perpendicular to the second seat surface are the same direction,
wherein the light beam reflected by the mirror is emitted from an emitting opening provided on the casing to an outside of the scanning optical device,
wherein as the scanning optical device is viewed in a rotational axis direction of the rotatable polygon mirror from a side of the lid, the lid covers the first lens and the rotatable polygon mirror, and further covers at least the first spring and the second spring, of the mirror, the first spring and the second spring,
wherein the lid is provided with an opening or a cutout portion through which an inside of the casing is exposed on a downstream side of the second lens in an optical axis direction of the light beam passing through the second lens and an advancing direction of the light beam passing through the second lens, and
wherein in a state in which a part of the opening of the casing is covered by the lid, the first lens and the rotatable polygon mirror are in a space formed and obstructed by the lid, the casing and the second lens held by the second seat surface.

10. The scanning optical device according to claim 9, wherein as viewed in a longitudinal direction of the second lens and perpendicular to the rotational axis direction of the rotatable polygon mirror, the lid includes a first part parallel to the first seat surface and a second part extending from the first part to the rotational axis direction, and
wherein the space is formed by the second part of the lid and the second lens being close to each other.

11. The scanning optical device according to claim 9, wherein an area of the opening or the cutout portion of the lid is larger than an area of the emitting opening.

12. The scanning optical device according to claim 9, wherein the opening of the lid is formed by a plurality of through holes.

13. The scanning optical device according to claim 12, wherein a total area of the plurality of the through holes is larger than an area of the emitting opening.

14. An image forming apparatus comprising:
the scanning optical device according to claim 10;
the scanned member on which an electrostatic latent image is formed by the scanning optical device;
a developing portion configured to develop the electrostatic latent image with toner and to form a toner image;
a transfer portion configured to transfer the toner image to a recording material; and
a fixing portion configured to fix the toner image, transferred by the transfer portion, onto the recording material.

15. The image forming apparatus according to claim 14, further comprising a discharge tray configured to receive the recording material on which the toner image is fixed and which is discharged outside the image forming apparatus,
wherein when as viewed in a longitudinal direction of the mirror, an imaginary line extending a top surface of the lid from the second lens toward the mirror is defined as a first imaginary line, a part of the discharge tray is disposed below the first imaginary line at least between the second lens closest to the rotatable polygon mirror and the mirror.
